(19) United States
(12) Patent Application Publication
(10) Pub. No.: US 2016/0124737 A1
(43) Pub. Date: May 5, 2016

(54) AUTOMATED GENERATION OF AN APPLIANCE FOR A COMPUTING MACHINE

(71) Applicant: CORE-SOFTWARE GMBH, Fehraltdorf (CH)

(72) Inventor: Sacha Dubois, Fehraltdorf (CH)

(73) Assignee: Core-Software GMBH, Fehraltdorf (CH)

(21) Appl. No.: 14/889,720

(22) PCT Filed: May 5, 2014
(86) PCT No.: PCT/EP2014/059075

§ 371 Date: Nov. 6, 2015

(30) Foreign Application Priority Data
May 6, 2013 (EP) 13166661.2

(51) Int. Cl. G06F 9/445

(52) U.S. Cl. CPC G06F 8/63

(57) ABSTRACT

A computer implemented method for generating an appliance for a computing machine comprises: running a builder accessible by a user; the builder providing a selection of settings for configuring a system platform to the user; the builder providing a selection of applications to the user; the user choosing and adjusting system platform configuration settings from the selection of settings for configuring a system platform to the user; the user choosing at least one application from the selection of applications; the builder evaluating kernel modules and parameters required for running the at least one chosen application with the chosen and adjusted platform configuration settings; the builder evaluating system features required for running the at least one chosen application with the chosen and adjusted platform configuration settings; the builder composing a kernel component with the evaluated kernel modules and parameters; the builder composing a system platform initializing component with the evaluated system features; the builder assembling an appliance image comprising a boot loader, the kernel component, the system platform initializing component and the at least one chosen application. The method according to the invention allows for providing tailored, fast and low resource demanding appliances.

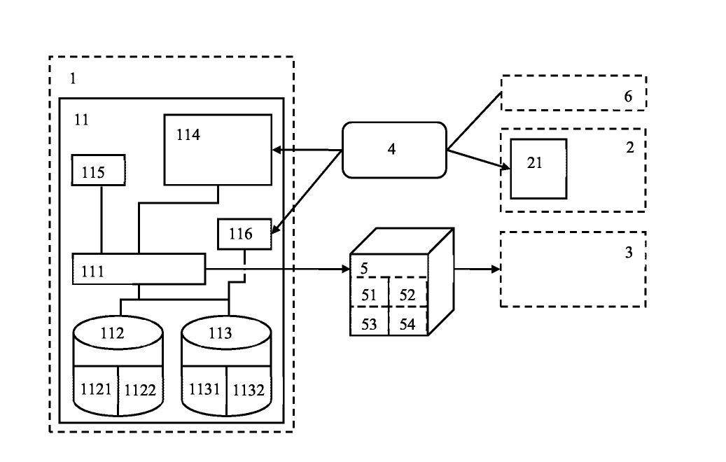

### TECHNICAL FIELD

The present invention relates to a computer implemented method for generating an appliance for a computing machine and more particularly to a computer program and system for generating an appliance for a computing machine. Such methods, computer programs and systems can be used for automated generation of computer appliances comprising application components and operating system components.

### BACKGROUND ART

For conveniently and efficiently operating computing machines it is necessary to run suitable operating systems. In the past every hardware vendor has developed his own operating system to best fit for his products and for keeping the control on software or applications running on it. In such systems underlying restrictions and certification tests were applied for software vendors to bind them on the respective system platform. For example, the company Hewlett-Packard Development Company, L.P. (HP) sticks to their Hewlett Packard Unix operating system (HP-UX) that is running on its parallel/precision architecture reduced instruction set computer (PA-RISC) system platforms and Itanium system platforms. Other examples are the company Sun Microsystems/Oracle Corporation with its Solaris operating system that runs on x86 system platforms and on SPARC based system platforms and the company International Business Machines Corporation (IBM) with its advanced interactive executive (AIX) operating system running on POWER system platforms.

However, the last recent years brought a consolidation in this regard wherein comparably expensive computer systems got more and more replaced with less expensive computer systems such as the x86 system platforms provided by companies as Intel Corporation or Advanced Micro Devices, Inc. (AMD). This fact has given the generally open source Linux operating systems a hard push and gave the reams of different Linux distributions such as Red Hat, SuSE, Debian, ubuntu and others an ascendency. Linux operating systems share the same Linux base system and kernel but provide different software stacks and application portfolios called bundles. Also, installation tools, administration utilities and even package managers as well as the default file systems are not the same in different Linux distributions.

Despite these differences, Linux distributions have in common that they provide a multipurpose operating system that can be installed on high-end server systems and on desktop systems similarly. They have to provide drivers like network adapters, SCSI, fibre channel controllers and the like for very many combinations of hardware. They also provide or include administration software, e.g., for network bonding, fibre channel multipathing, firewall, logical volume management and so on.

A downside of providing such a high grade of flexibility in operating systems such as in the mentioned Linux operation systems is the risk of software problems and malfunction as well as a considerable administration effort to keep the software and operating system up to date for preventing out-aging and security issues. Such updates often come on a weekly basis from the distributors and provide updates for software bugs and security fixes. Moreover, such operating systems are usually comparably resource consuming in terms of memory space required and in terms of of processing power.

Particularly considering that in recent years virtual machines became increasingly popular as computing machines, the situation got worse and the downsides mentioned hereinbefore got more and more important. The combination of using comparably inexpensive hardware together with powerful virtualization platforms such as, e.g., the known products VMware of the company VMware, Inc., XenServer of the company Citrix Systems, Inc. or Hyper-V of the company Microsoft Corporation allows operating a plurality of virtualised machines managed on a single console from one person and running on the same hardware. The virtualization platform takes care of storage, network and managing the assigned central processing unit (CPU) and memory resources.

For example, today often separate virtual machines are used for implementing servers performing specific tasks such as running applications or services wherein these virtual machines are operated on one single physical machine or on few plural physical machines. Since all the virtual machines are running highly flexible operating systems as described above the demands to the physical environment particularly in terms of performance and security are increasingly high.

Therefore, there is a need for efficiently operating computing machines at a comparably high performance wherein the demands to the physical infrastructure are to keep comparably low and the security is comparably high.

### DISCLOSURE OF THE INVENTION

According to the invention this need is settled by a computer implemented method as it is defined by the features of independent claim 1, by a computer program as it is defined by the features of independent claim 10 and by a computer system as it is defined by the features of independent claim 15. Preferred embodiments are subject of the dependent claims.

In particular, the invention deals with a computer implemented method for generating an appliance for a computing machine, comprising: running a builder accessible by a user; the builder providing a selection of settings for configuring a system platform to the user; the builder providing a selection of applications to the user; the user choosing and adjusting system platform configuration settings from the selection of settings for configuring a system platform to the user; the user choosing at least one application from the selection of applications; the builder evaluating kernel modules and parameters required for running the at least one chosen application with the chosen and adjusted platform configuration settings; the builder evaluating system features required for running the at least one chosen application with the chosen and adjusted platform configuration settings; the builder composing a kernel component with the evaluated kernel modules and parameters; the builder composing a system platform initializing component with the evaluated system features; the builder assembling an appliance image comprising a boot loader, the kernel component, the system platform initializing component and the at least one chosen application.

The term “appliance” as used herein can relate to a specific software package comprising all necessary computer programs and configuration for running at least one computer application on a system platform. It can particularly comprise an operating system or respective components suitable for the system platform and the at least one computer application. Since, e.g., in modern computing environments often virtual machines are used appliances do not mandatorily comprise any computer hardware. The term “computing machine” as used in the context of the invention can relate to any suitable single physical device such as server computer, a workstation computer, a portable computer or a system or combination of plural such physical devices. It can particularly also relate to a virtual machine being a machine provided by a virtualization platform and run on a physical device. Also, it can relate to combinations of physical devices and virtual machines.

The term “running a builder” as used in connection with the invention can relate to the execution of a computer program on a computing machine different from the computing machine of the appliance. For example, the builder can be executed by running a computer program on a server computer which is communicating with the user. Thereby, the computer program can be stored on the hard disk of the server computer and its execution can be processed by the central processing unit of the server computer in the memory of the server computer.

Providing the selection of settings for configuring the system platform to the user and the user choosing and adjusting the system platform configuration settings can be performed by means of a graphical user interface on a client computer accessible by the user and by transferring data signal structures corresponding to this selection and to the choices and/or adjustments of the user between the builder and the client computer, e.g. via a network. Correspondingly, also providing the selection of applications to the user and the user choosing the at least one application can be performed by means of the graphical user interface on the client computer and by transferring data signal structures corresponding to this selection and to the choices of the user between the builder and the client computer.

The term “system platform” as used herein can relate to virtual and/or physical computer hardware of a computer system and the architecture specifying the relations, competences and inter-functioning thereof. When configuring the system platform in the method according to the invention the respective system platform can be or can represent the computing machine the appliance prospectively is running on.

The term “application” or computer application in context of the invention can relate to any computer program or plurality of computer programs providing particular functionality. For example, a computer application can be a web server application as software helping to deliver web content accessible via the Internet, a database server application providing database management services and databases, an office application providing office software such as a text writing tool, a file server providing services for storing data files, etc. The selections of setting for configuring the system platform and of applications can be provided to the user via a user interface such as a graphical user interface (GUI) running on a client device or computer of the user.

The term “kernel” as used herein can relate to a central component of an operating system which conceptually is a bridge between applications and data processing done at the hardware level. The kernel's responsibilities usually comprise the management of system resources such as processors, input output (I/O) devices and the like. The kernel typically makes functionalities of the resources available to applications through inter-process communication mechanisms and system calls. The term “kernel modules” in context of the invention can relate to modules the kernel comprises of, such as a device manager, e.g. UDEV of Linux kernels, a (extended) file system, e.g. EXT of Linux and Unix kernels, a logical volume management, e.g. LVM of Linux kernels, a network files system, e.g. NFS of Linux and Unix kernels, and the like. The kernel component as composed by the builder can be a kernel and particularly a Linux kernel.

The term “system features” in connection with the invention can relate to any features of the system platform or computing machine which is required on top of the kernel for appliances. Such system features can, e.g., comprise protocols such as a simple network management protocol (SNMP), a network time protocol (NTP) etc., a standard for data logging (Syslog), a network file system (NFS), network processing tools such as iptables or Netfilter of Linux, etc., and the like.

Evaluation of the kernel modules and parameters can be performed by the builder obtaining data or data signals corresponding to the choices and adjustments of the user, by the builder considering the kernel modules and parameter involved in accordance with predefined rules and by the builder providing the respective kernel modules and parameters as data or data signal structure. Similarly, evaluation of the system features can be performed by the builder obtaining data or data signals corresponding to the choices and adjustments of the user, by the builder considering the system features involved in accordance with predefined rules and by the builder providing the respective system features as data or data signal structure.

The system platform initializing component composed by the builder can be a process or processing means that is direct or indirect ancestor of all other processes running on the system platform. It can automatically adopt all orphaned processes. Usually, this process is the first process started during booting and is started by the kernel using a hard-coded filename. The system platform initializing component can be equivalent to and for replacing an init process of a Linux operating system and respective start scripts.

In the given context the term “image” can relate to a virtual disk image or to an ISO image. Thereby, ISO image can be an archive file in accordance with standard no. 9660 of the international organization for standardization (ISO). However, the appliance image can be an image file in any suitable format. The method according to the invention can further comprise the builder providing the appliance image to the user wherein such provision can, e.g., be performed by transferring data or data signals corresponding to the appliance via the Internet.

Composing the kernel component and the system platform initializing component can be performed by the builder obtaining the data or data signal structure corresponding to the kernel modules and parameters or system features, by packaging the this data or data signal structure in accordance with predefined rules and functions and by providing the kernel component or system platform initializing component as respective data or data signal structure. Similar data transformation can be performed by the builder assembling the appliance image wherein respective data or data signal structure is provided.

The method according to the invention allows for providing an immutable or static appliance. In particular, it allows for providing an appliance wherein its operating system is tailored to the at least one chosen application. This allows for equipping the appliance with the necessary and only the necessary components. In particular, in an environment with virtual machines the method according to the invention makes it possible to providing comparably low sized full functioning appliances. E.g., the appliance image excluding the at least one application can have a size of about 20 megabytes (MB) which is low compared to the common size of about 4 gigabytes (GB) to 6 GB of state of the art standard operating systems such as Microsoft Windows or Linux. For example, the only remaining part of a Linux operating system in the appliance image can be the boot loader, a modified kernel and the initramfs to mount the Linux volume manager (LVM) based root file system. Thereby, the system platform initializing component can replace the Linux init program and the /etc/rd.d start scripts and can configure the network services, NFS mounts if required and start the application. Therein, the system platform initializing component can be inimitably and unique for every appliance and can be modularly assembled and compiled according to the user's need and/or required by the at least one chosen application.

Thus, with the method according to the invention it can be prevented that every appliance running on a virtual machine comprises a full operating system the biggest part of which is never used but, instead, decreases performance and increases resource demands. In other words, the method according to the invention allows for eliminating downsides of a multipurpose operating system by removing unnecessary components such as, e.g. init scripts, shell, user login, administration tools, system utilities, etc. and by replacing these with the system platform initializing component. For example, in known systems the shell or operating system user interface often is a core component which provides utilities for modification of files, authorization of file access, user management, process management and the like. By allowing to omit such shell within an appliance the method according to the invention allows for lightening the appliance and increasing security.

Thus, the method according to the invention allows for providing tailored, fast, secure and low resource demanding appliances. In particular, the appliance generated with the method according to the invention allows for increasing computer or processing performance of the computing machine and system running the appliance and in the meantime to safe resources such as memory resources, disk space and the like.

Furthermore, since the operating system of the appliance is tailored to the requirements of the at least one chosen application it can be prevented that components and utilities potentially being misused are running on the computing machine. For example, many applications do not require a user space such that many appliances provided in accordance with the invention can be provided without user space. Like this, no login to the computing machine is possible such that, e.g., malware can be prevented from accessing the computing machine by logging-in to the system. Furthermore, since the appliance provided in accordance with the invention can only comprise a minimum of operating system components no unnecessary utilities and the like are accessible on the computing machine. Like this, security of the appliance and of the computing machine can be increased.

Preferably, the computing machine for which the appliance is generated is a virtual machine (VM) running on a virtualization platform. In such virtualized environments the method according to the invention can be particularly beneficial. Considering that a plurality of appliances can be run on the same hardware infrastructure appliances generated in accordance with the invention allow for particularly increasing the performance and for decreasing the resources demands.

Furthermore, since many tasks usually performed by the operating system are performed by the virtualization platform underlying the VM the method according to the invention allows for using the virtualization platform for these tasks such that no means for providing the tasks has to be comprised within the appliance image. For example, if the user is assembling an appliance to be run on a VM as computing machine a virtual disk assigned to the VM in the virtualization platform and loadbalanced over two fibre channel path (SAN Devices) or coming over a network as redundant iSCSI or NFS device can be the back of the appliance. Thereby, mirroring (RAID) for data protection and backup with snapshots can already be made on a storage subsystem of the virtualization platform. Network interfaces can work with generic drivers, interface failover (bonding) can be done by the virtualization platform as well. Thus, the appliance provided in accordance with the invention does not require composing respective components and providing respective functionalities but the virtualization platform components can be used. Like this, many critical parts usually done by an operating system can be done by the virtualization platform such that this does not need to be fully comprised in the appliance. This allows for providing an even further compacted and secured appliance with increasing performance and decreasing resource demands.

In other words, due to the fact that an appliance running on a VM only needs a reduced set of drivers and operating system features such as file systems and basic kernel features such as process scheduling, handling devices, etc. the remaining operating system within the appliance can become unadministratable by removing the core parts as the shell and system utilities. As this prevents from making changes to the system, no modifications which are not directly related to the at least one application can be made to the system. The at least one application intended to run within the appliance may require to be sealed with its configuration files and libraries together with the kernel component and the system platform initializing component to a runnable virtual machine. Only the application data and log files can be allowed to be stored on an external file system to keep the maintainability.

Preferably, the evaluated kernel modules and parameters required for running the at least one chosen application with the chosen and adjusted platform configuration settings comprise one or more of fourth extended file system features, network file system features, device management features, Ethernet features, encrypting features decrypting features and logical volume management features. Such modules and parameters are used in many applications such that they are often required in appliances. Therefore, such a method allows for efficiently providing an appliance.

Preferably, the evaluated kernel modules and parameters required for running the at least one chosen application with the chosen and adjusted platform configuration settings comprise system platform initializing component identification features. Such features allow that the kernel component of the appliance can identify the dedicated system platform initializing component and that the appliance only runs on the computing machine if a verified combination of kernel component and system platform initializing component is run on the computing machine. Like this, it can be prevented that untrusted combinations of kernel components and system platform initializing component are run such that the security of the appliance can be further increased.

Preferably, the evaluated system features required for running the at least one chosen application with the chosen and adjusted platform configuration settings comprise one or more of network configuration features, application startup features, network file system mounting features, datastore features, data features, decryption features and configuration features. The application startup features can comprise a start command executable. By integrating such system features into the system platform initializing component the method allows for providing the necessary basis within the appliance required by many applications. Providing a shell or operating system user interface or a other respective system components is not necessary such that the shell and the like can be omitted from the appliance. This can increase security and performance of the appliance.

Preferably, the builder encrypts the kernel component and eventually also the at least one chosen application and composes the system platform initializing component with decryption features allowing to decrypt the kernel component. By integrating the decryption features into the system platform initializing component, it can be assured that the appliance can not be used unless being authorized to do so. Thus, security of the appliance can efficiently be increased.

Preferably, the kernel component and the system platform initializing component exclude any user management features such that the appliance image excludes any user management. Like mentioned above, many applications do not require any user management or not even any user. Therefore, respective user management features can be excluded from the appliance. And, many malware or hackers use the user management of target systems in order to misuses the target system. However, appliances excluding any user management features cannot be attacked in such a manner such that the security can be increased.

Preferably, the builder provides the selection of settings for configuring a system platform to the user for plural hardware architectures. Like this, the user can select in which environment the application is to run which makes the method flexible and efficient.

Preferably, the kernel component and the system platform initializing component exclude any hard disk management features such that the appliance image excludes any hard disk management. In this context, hard disk management features can comprise stat scripts features, disk monitoring features, log facility features, shell interactive features and the like. Many applications do not require any hard disk management such that respective hard disk management features can be excluded from the appliance. And, many malware or hackers use the hard disk management of the target system in order to misuses the target system. However, appliances excluding any hard disk management features cannot be attacked in such a manner such that the security of the appliance can be increased.

In a preferred embodiment the builder assembles a master boot record into the appliance image. In this context the term “master boot record” can relate to a special type of boot sector at the very beginning of partitioned computer mass storage devices like fixed disks, flash memories or removable drives. The master boot record can hold the information on how the logical partitions, containing file systems, are organized on that medium. By assembling the master boot record into the appliance image, the appliance can be preinstalled on the computing machine. In particular, the appliance image can be a preinstalled virtual disk image that can be imported on an arbitrary virtualization platform. Thereby, the appliance image can comprise the complete running appliance or system.

Preferably, the builder evaluates file system features required for running the at least one chosen application on the selected platform, composes an initial ram file system component with the evaluated file system features and assembles the initial ram file system component into the appliance image. Since many applications require a ram file system this allows for efficiently providing an appliance. In particular, when the appliance image is provided as a preinstalled virtual disk image that can be imported on an arbitrary virtualization platform such initial ram file system is often required.

Preferably, the builder assembles a management console into the appliance image. The management console can comprise a user interface such as, e.g., a graphical user interface. It can be adapted to provide information about the appliance running on a target platform. Also, it can be arranged to allow adaptations to be performed to the appliance running on the target platform. Such a console allows for efficiently managing the appliance. In particular, as the appliance image may not have a full operating system with utilities and system administration commands the appliance can be provided with the management console allowing viewing the appliance status and performing basic administration tasks like changing network address, resetting the administration password and the like.

Another aspect of the invention relates to a computer program comprising computer readable commands causing a computer to implement a builder in accordance with the method of any one of the preceding claims when being loaded to or executed by the computer. In this context, the term “loaded to or executed by a computer” can relate to any appropriate loading to or execution by any physical or virtual computing machine. Such a computer program allows for efficiently implementing the method described above and for providing the respective advantages and effects.

Preferably, the builder implemented by the commands of the computer program comprises a system platform configuration settings database, an application repository, a management interface arranged for the user to choose from and to adjust a selection of settings for configuring a system platform stored in the system platform configuration settings database and to choose from the selection of applications stored in the application repository, and a builder engine which evaluates kernel modules and parameters required for running at least one chosen application with the chosen and adjusted platform configuration settings, evaluates the system features required for running the at least one chosen application with the chosen and adjusted platform configuration settings, composes a kernel component with the evaluated kernel modules and parameters, composes a system platform initializing component with the evaluated system features, and assembles an appliance image comprising a boot loader, the kernel component, the system platform initializing component and the at least one chosen application.

Such a builder with the platform configuration settings database, the application repository, the management interface and the builder engine allows for particularly efficiently implementing the method described above and, thus, for providing the respective effects and advantages. Furthermore, the builder implemented by the commands of the computer program may comprise a middleware repository. This allows for providing options in this field such as, e.g., an application server, a messaging server and/or a ESB/SOA solution.

Thereby, the system platform configuration settings database preferably comprises system platform configuration information and a system platform repository with system platform components. Like this, the builder can on one hand gather and consider configuration information with regard to the system platform and on the other hand choose and gather the appropriate system platform components. Similarly, the application repository preferably comprises application configuration information and application components.

Preferably, the builder comprises an update manager which synchronizes the system platform configuration settings database and/or the application repository with a central source. The central source can be accessible via the Internet such that the databases and repositories can be updated by accessing the Internet and downloading new versions. Like this, the computer implemented appliance generation can be automatically held up to date wherein only the central source needs to be updated. In particular, when plural appliance generation systems are running in parallel the effort for keeping them updated can be minimized.

A further other aspect of the invention relates to a computer system comprising components adapted to implement a builder as described above. Such a computer system allows for efficiently running the computer program described before and thereby efficiently implementing the method described above and providing the respective advantages and effects.

These and other aspects of the invention will be apparent from and elucidated with reference to the embodiment(s) described hereinafter.

### BRIEF DESCRIPTION OF THE DRAWING

The method, computer program and computer system according to the invention are described in more detail herein below by way of exemplary embodiments and with reference to the attached FIGURE showing a schematic view of an embodiment of a computer system according to the invention comprising a computer executing commands of an embodiment of a computer program according to the invention implementing a builder of an embodiment of the method according to the invention.

### DESCRIPTION OF EMBODIMENTS

The FIGURE shows an embodiment of a computer system according to the invention comprising a server computer 1 executing commands of an embodiment of a computer program according to the invention implementing a builder 11 of an embodiment of the method according to the invention. The builder 11 comprises a builder engine 111, a system platform configuration settings database 112 connected to the builder engine 111, an application repository 113 connected to the builder engine 111 and a management interface 114 connected to the builder engine 111 and to a client computer 2 via the Internet 4. The system platform configuration settings database 112 comprises system configuration information 1121 and a system platform repository. The system configuration information 1121 comprises configuration data such as the platform type, e.g. x86_64 or i586, network configuration, e.g. internet protocol (IP) address, gateway name, domain name server (DNS) and netmask, operating system type, e.g. Linux and FreeBSD), etc. which is required to build an appliance. The system platform repository comprises the latest system platform components 1122, e.g. boot loaders, standard kernels or initramrc, for each provided system platform architecture, e.g. x86_64 or i586.

The application repository 113 comprises application configuration information 1131 and application components 1132. For example, the applications can be web server applications such as Apache Web Server, database server applications such as mySQL, content management servers, file server applications and/or the like.

The builder 11 further comprises a license manager 115 connected to the builder engine 111 and an update manager 116 connected to the system platform configuration settings database 112, to the application repository 113 and to a central source 6 via the Internet 4.

In the following, operation of the computer system of the FIGURE is explained in more detail:

On request, the management interface 114 provides a graphical user interface 21 on the client computer 2 via the Internet 4. Thereby, the graphical user interface 21 is used for providing the user with a selection of setting for configuring a system platform stored in the system platform configuration settings database 112 and for providing the user with a selection of applications stored in the application repository 113. The user then selects at least one application 54. Furthermore, he selects and adjusts the system platform configurations in accordance with a computing machine 3 for which the at least one application is chosen. The computing machine 3 can, e.g., be a virtual machine running on a specific virtualization platform.

The user management interface 114 transfers the selections of the user together with other information about the user session to the builder engine 111 which verifies the user's input data or selections, adjustments and choices. Thereby, the builder engine 111 verifies with the license manager 114 if the user has the necessary licenses for the selections or choice performed. It is to be noted that purchasing and licensing can be done in any suitable known manner. Even though purchasing and licensing is an important issue in the appliance generation, it can be performed in known manner and is therefore not discussed in more detail herein. For example, the license manager 114 can be in contact with a license server to count and verify the active licences the user. Licences can be ordered directly on the license server and the user can receive a license key for each license package ordered.

After verifying the data transferred by the user management interface 114, the builder engine 111 evaluates kernel modules and parameters required for running the at least one chosen application with the chosen and adjusted platform configuration settings and composes a kernel component 51 with the evaluated kernel modules and parameters. The builder engine 111 also evaluates system features required for running the at least one chosen application 54 with the chosen and adjusted platform configuration settings and composes a system platform initializing component 52 with the evaluated system features.

The builder engine further assembles an ISO image 5 as appliance image comprising a boot loader 53, the kernel component 51, the system platform initializing component 52 and the at least one chosen application 54. The ISO image 5 is then transferred by the builder engine 111 to the computing machine 3.

The update manager 116 is regularly synchronizing the system platform configuration settings database 112 and the application repository 113 with the central source 6. The central source 6 is storing and providing the latest application configuration information 1131 and application components 1132 as well as the latest system configuration information 1121 and system platform components 1122.

While the invention has been illustrated and described in detail in the drawing and foregoing description, such illustration and description are to be considered illustrative or exemplary and not restrictive. It will be understood that changes and modifications may be made by those of ordinary skill within the scope and spirit of the following claims. In particular, the present invention covers further embodiments with any combination of features from different embodiments described above and below.

The invention also covers all further features shown in the FIGURE individually although they may not have been described in the afore or following description. Also, single alternatives of the embodiments described in the FIGURE and the description and single alternatives of features thereof can be disclaimed from the subject matter of the invention or from disclosed subject matter. The disclosure comprises subject matter consisting of the features defined in the claims ort the exemplary embodiments as well as subject matter comprising said features.

Furthermore, in the claims the word “comprising” does not exclude other elements or steps, and the indefinite article “a” or “an” does not exclude a plurality. A single unit or step may fulfil the functions of several features recited in the claims. The terms “essentially”, “about”, “approximately” and the like in connection with an attribute or a value particularly also define exactly the attribute or exactly the value, respectively. The term “about” in the context of a given numerate value or range refers to a value or range that is, e.g., within 20%, within 10%, within 5%, or within 2% of the given value or range. Any reference signs in the claims should not be construed as limiting the scope.

A computer program may be stored/distributed on a suitable medium, such as an optical storage medium or a solid-state medium supplied together with or as part of other hardware, but may also be distributed in other forms, such as via the Internet or other wired or wireless telecommunication systems. In particular, e.g., a computer program can be a computer program product stored on a computer readable medium which computer program product can have computer executable program code adapted to be executed to implement a specific method such as the method according to the invention. Furthermore, a computer program can also be a data structure product or a signal for embodying a specific method such as the method according to the invention

1. A computer implemented method for generating an appliance for a computing machine, the method comprising:
running a builder accessible by a user;
the builder providing a selection of settings for configuring a system platform to the user;
the builder providing a selection of applications to the user;
the user choosing and adjusting system platform configuration settings from the selection of settings for configuring a system platform to the user;
the user choosing at least one application from the selection of applications;
the builder evaluating kernel modules and parameters required for running the at least one chosen application with the chosen and adjusted platform configuration settings;
the builder evaluating system features required for running the at least one chosen application with the chosen and adjusted platform configuration settings;
the builder composing a kernel component with the evaluated kernel modules and parameters;
the builder composing a system platform initializing component with the evaluated system features; and
the builder assembling an appliance image comprising a boot loader, the kernel component, the system platform initializing component and the at least one chosen application.

2. The method according to claim 1, wherein the computing machine is a virtual machine running on a virtualization platform.

3. The method according to claim 1, wherein the evaluated kernel modules and parameters required for running the at least one chosen application with the chosen and adjusted platform configuration settings comprise one or more of fourth extended file system features, network file system features, device management features, Ethernet features, encrypting features, decrypting features, and logical volume management features.

4. The method according to claim 1, wherein the evaluated kernel modules and parameters required for running the at least one chosen application with the chosen and adjusted platform configuration settings comprise system platform initializing component identification features.

5. The method according to claim 1, wherein the evaluated system features required for running the at least one chosen application with the chosen and adjusted platform configuration settings comprise one or more of network configuration features, application startup features, network file system mounting features, datastore features, data features, and configuration features.

6. The method according to claim 1, wherein the builder encrypts the kernel component and composes the system platform initializing component with decryption features allowing to decrypt the kernel component.

7. The method according to claim 1, wherein the builder provides the selection of settings for configuring a system platform to the user for plural hardware architectures.

8. The method according to claim 1, wherein the builder assembles a master boot record into the appliance image.

9. The method according to claim 1, wherein the builder evaluates file system features required for running the at least one chosen application on the selected platform, composes an initial ram file system component with the evaluated file system features and assembles the initial ram file system component into the appliance image.

10. The method according to claim 1, wherein the builder assembles a management console into the appliance image.

11. A computer program storage medium comprising computer readable commands causing a computer to implement a builder in accordance with the method of claim 1 when being loaded to or executed by the computer.

12. The computer program storage medium according to claim 11, wherein the builder comprises
a system platform configuration settings database,
an application repository,
a management interface arranged for the user to choose from and to adjust a selection of settings for configuring a system platform stored in the system platform configuration settings database and to choose from the selection of applications stored in the application repository, and
a builder engine which
evaluates kernel modules and parameters required for running at least one chosen application with the chosen and adjusted platform configuration settings,
evaluates system features required for running the at least one chosen application with the chosen and adjusted platform configuration settings,
composes a kernel component with the evaluated kernel modules and parameters,
composes a system platform initializing component with the evaluated system features, and
assembles an appliance image comprising a boot loader, the kernel component, the system platform initializing component and the at least one chosen application.

13. The computer program storage medium according to claim 12, wherein the system platform configuration settings database comprises system platform configuration information and a system platform repository with system platform components.

14. The computer program storage medium according to claim 12, wherein the application repository comprises application configuration information and application components.

15. The computer program storage medium according claim 12, wherein the builder comprises an update manager which synchronizes the system platform configuration settings database and/or the application repository with a central source.

16. A computer system comprising components adapted to implement a builder in accordance with the method of claim 1.
